(19) United States
(12) Patent Application Publication
(10) Pub. No.: US 2024/0155987 A1
(43) Pub. Date: May 16, 2024

(54) SEAWEED CULTIVATION SYSTEM

(71) Applicant: W. L. Gore & Associates, Inc., Newark, DE (US)

(72) Inventors: Norman E. Clough, Landenberg, PA (US); Varendra N. Silva, Flagstaff, AZ (US); Raymond M. Wnenchak, Delray Beach, FL (US)

(21) Appl. No.: 18/388,416

(22) Filed: Nov. 9, 2023

Related U.S. Application Data
(60) Provisional application No. 63/597,196, filed on Nov. 8, 2023.
(60) Provisional application No. 63/424,326, filed on Nov. 10, 2022.

(51) Int. Cl. A01G 33/00

(52) U.S. Cl. CPC A01G 33/00

(57) ABSTRACT

Various embodiments are directed toward cultivation systems configured to catch, retain and viably maintain spores, and, more specifically cultivation systems having a growth media configured to provide effective catchment, attachment, and growth of seaweed while providing anti-biofouling properties. The cultivation system may include a growth media with a rough surface supported by a support structure.

### CROSS-REFERENCE TO RELATED APPLICATION

This application claims the benefit of Provisional Application No. 63/597,196, filed Nov. 8, 2023, and also claims the benefit of Provisional Application No. 63/424,326, filed Nov. 10, 2022, which are incorporated herein by reference in their entireties for all purposes.

### FIELD

The present disclosure relates generally to cultivation systems and, more specifically, to seaweed cultivation systems configured to provide improved catchment and seeding.

### BACKGROUND

The current process to cultivate seaweed from spores involves using textured nylon “culture strings” or “seed strings” to which the spores weakly attach during a lab-based seeding process that precedes installation at a seaweed farm. The culture strings containing weakly attached juvenile seaweed (gametophytes and sporophytes) are then wound onto ropes at a seaweed farm, where the ropes are subsequently deployed and placed under water. The process is inherently inconsistent in terms of yield and throughput due to low initial seeding of the culture string, loss of weakly attached seaweed spores and juvenile plants, and biofouling (i.e., the contamination of the seed string with unwanted species of seaweed and other organisms). Final density of sporophytes that mature and remain attached can often be a tenth of the initial seeding density. These low densities are observed even when commercial binders or bioglues are utilized to improve the catchment and retention of the spores to the culture strings. Additionally, traditional culture strings are made up of 3-ply yarns of natural or synthetic materials that are tightly twisted together.

Biofouling can severely reduce seaweed growth and yields. Traditionally, effective biofouling-resistant materials (smooth, low coefficient of friction films) also reduce seaweed growth and yield due to poor attachment between these substrates and the maturing seaweed plants. Biofouling-resistant materials have also traditionally exhibited poor catchments of spores and juvenile seaweed plants during the initial seeding of the culture strings. Other factors affecting yield and throughput include the ease by which the seaweed can be damaged from, for example, water currents, changes in temperature, and nutrient availability. Further, poor packaging and handling can result in damage and loss of juvenile seaweed plants that are weakly attached to the culture strings. There is a need for a substrate that can provide for effective catchment, attachment and growth of seaweed while also providing effective anti-biofouling properties.

### SUMMARY

Various embodiments are directed toward cultivation systems configured to catch, retain and viably maintain spores, and, more specifically cultivation systems having a growth media configured to provide effective catchment, attachment, and growth of seaweed while providing anti-biofouling properties. The cultivation system may include a growth media with a rough surface supported by a support structure.

According to one example (“Example 1”), a seaweed cultivation system for use in an aquatic environment is disclosed, the system comprising a support structure and a microporous growth media supported by the support structure. The microporous growth media has a catchment surface.

According to various examples, the catchment surface optionally has a surface roughness having an average Ra value inclusively ranging from 1.0 μm to 50 μm.

According to various examples, the catchment surface optionally has a surface roughness having an average Ra value inclusively ranging from 2.5 μm to 20 μm.

According to various examples, the catchment surface of the microporous growth media optionally has a bubble point inclusively ranging from 0.1 psi to 3.0 psi.

According to various examples, the microporous growth media optionally has a plurality of openings distributed across at least a portion of the catchment surface. The plurality of openings optionally defines an average opening size inclusively ranging from 5 microns to 200 microns. The plurality of openings optionally defines an average opening size inclusively ranging from 20 microns to 100 microns.

According to various examples, the microporous growth media optionally has a porosity inclusively ranging from 50% to 90%.

According to various examples, the microporous growth media is optionally a polymer. The polymer optionally forms a membrane. The polymer is optionally an expanded polymer defining spaces between polymer elements. The polymer is optionally selected from the group consisting of expanded fluorinated ethylene propylene (eFEP), porous perfluoroalkoxy alkane (PFA), expanded ethylene tetrafluoroethylene (eETFE), expanded vinylidene fluoride co-tetrafluoroethylene or trifluoroethylene polymer (eVDF-co(TFE or TrFE)), expanded polytetrafluoroethylene (ePTFE), and expanded polyethylene (ePE). The polymer is optionally ePE.

According to various examples, the support structure and the growth media optionally together form a composite. The support structure of the composite is optionally a polymer. The support structure optionally comprises a different polymer than the microporous growth media polymer.

According to various examples, the catchment surface is optionally free of adhesive, bioglue, or binder.

According to various examples, the microporous growth media is optionally formed as a yarn, a rope, or a braid.

According to various examples, the microporous growth media is optionally braided, twisted, knitted, or weaved with the support structure.

According to various examples, the catchment surface optionally has a surface energy of less than 35 dynes/cm.

According to various examples, the seaweed cultivation system optionally comprises a plurality of immature seaweed plants engaging the catchment surface. The plurality of immature seaweed plants optionally comprises seaweed spores, gametophytes, sporophytes, propagules, or fragmented seaweed plants. The genus of engaged immature seaweed plants are optionally selected from the group comprising Palmaria, Porphyra, Saccharina, Neopyropia, Grasscilaria, kelp, and Asparagopsis. The engaged immature seaweed plants are optionally Parmaria.

According to various examples, the plurality of immature seaweed plants optionally engages the catchment surface during an initial seeding process to define a first portion of immature seaweed plants that are securely entrapped by the catchment surface and a second portion of immature seaweed plants that are temporarily entrapped by the catchment surface until subjected to a water current. Optionally, greater than 50% of the plurality of immature seaweed plants are the first portion that are retained after exposure to the water current. The water current is optionally created through exposure to a flume process immediately after completion of the initial seeding. The percentage of retained immature seaweed plants is optionally ascertainable immediately subsequent to the flume process.

According to various examples, the plurality of immature seaweed plants optionally engages the catchment surface during an initial seeding process to define a first portion of immature seaweed plants that are securely entrapped by the catchment surface and a second portion of immature seaweed plants that are temporarily adhered to the catchment surface until subjected to an incubation period. Optionally, greater than 50% of the plurality of immature seaweed plants are the first portion that are retained after the expiration of the incubation period. The expiration of the incubation period optionally takes place approximately two weeks after the initial seeding. A percentage of retained immature seaweed plants is optionally ascertainable at the expiration of the incubation period.

According to various examples, the plurality of immature seaweed plants optionally engages the catchment surface during an initial seeding process followed by an incubation period to define a first portion of immature seaweed plants that are securely entrapped by the catchment surface and a second portion of immature seaweed plants that are temporarily entrapped by the catchment surface until subjected to a submersion in an oceanic farming environment. Optionally, greater than 50% of the plurality of immature seaweed plants are the first portion that are retained after the submersion in the oceanic farming environment. The submersion in the oceanic farming environment optionally takes place approximately four weeks after the initial seeding. A percentage of retained immature seaweed plants is optionally ascertainable during the submersion in the oceanic farming environment. The submersion in the oceanic farming environment optionally takes place approximately four weeks after the initial seeding. A percentage of retained immature seaweed plants is optionally ascertainable during a harvesting from the oceanic farming environment

According to various examples, the lodged immature seaweed plants are optionally retained via selective attachment upon intentionally differentiated surface textures.

According to various examples, a laid rope for use in seaweed cultivation, the laid rope having a rope axis and rope axial length, the rope including a first yarn and a second yarn, wherein the first yarn includes a first growth fiber and a first strength fiber, wherein the first growth fiber and the first strength fiber axially are aligned and twisted about each other to define a first left-handed twisting fiber-to-fiber engagement, wherein the second yarn includes a second growth fiber and a second strength fiber, wherein the second growth fiber and the second strength fiber are axially aligned and twisted about each other to define a second left-handed twisting fiber-to-fiber engagement, wherein the first yarn and the second yarn are axially aligned and twisted about each other to define a right handed twisting yarn-to-yarn engagement, wherein the first left-handed twisting fiber-to-fiber engagement disposes the first strength fiber and the first growth fiber to define a first contact line along the rope axial length where one fiber repeatedly contacts the other fiber, the first contact line further defining adjacent portions of the first strength fiber and the first growth fiber that are in an angular relationship to each other to define a first groove of the first yarn, wherein the second left-handed twisting fiber-to-fiber engagement disposes the second strength fiber and the second growth fiber to define a second contact line along the rope axial length where one fiber repeatedly contacts the other fiber, the second contact line further defining adjacent portions of the second strength fiber and the second growth fiber that are in an angular relationship to each other to define a second groove of the second yarn.

According to various examples having the first growth fiber and the second growth being expanded polyethylene.

According to various examples, the laid rope having the first growth fiber and the second growth fiber being monofilament polypropylene.

According to various examples, the laid rope having a catchment enhancing fiber is included in first yarn, the second yarn, or both the first and second yarn.

According to various examples, the laid rope having a catchment enhancing fiber of spun polyester.

According to various examples, a seaweed cultivation system comprising a laid rope formed from twisted yarns comprising growth fibers and strength fibers.

According to various examples, a seaweed cultivation system comprising laid rope wherein the plurality of immature seaweed plants engage the first groove and second groove along the length of the laid rope during an initial seeding process.

According to various examples, seaweed cultivation system wherein the laid rope is knotted to form a net.

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a color photographic image portraying an embodiment of the disclosure in which a growth media membrane is wrapped around a support structure, wherein the support structure is partially exposed;

FIG. 2 is an SEM image portraying an embodiment of the disclosure in which the growth media membrane is fully wrapped around the support structure, wherein the image is provided to-scale at ×32 magnification at the scale displayed in the image;

FIG. 3 is an SEM image portraying a closer view of the embodiment of FIG. 2, provided to-scale at ×70 magnification at the scale displayed in the image;

FIG. 4 is a color photographic image portraying an embodiment of the disclosure in which a growth media is twisted with a support structure to form a twine;

FIG. 5 is a color image portraying a surface topography of a first sample of a growth media of an embodiment of the disclosure, wherein the image is provided to-scale at ×150 magnification with false coloring indicating a variation in the surface topography as indicated in the axes and scales displayed in the image;

FIG. 6 is a color image portraying a surface topography of a second sample of a growth media of an embodiment of the disclosure, wherein the image is provided to-scale at ×150 magnification with false coloring indicating a variation in the surface topography as indicated in the axes and scales displayed in the image;

FIG. 7 is a color image portraying a surface topography of a third sample of a growth media of an embodiment of the disclosure, wherein the image is provided to-scale at x150 magnification with false coloring indicating a variation in the surface topography as indicated in the axes and scales displayed in the image;

FIG. 8 is a color graphical representation of the total profile and the roughness profile of the surface topography of FIG. 5 taken in a horizontal orientation across the imagery of FIG. 5;

FIG. 9 is a graphical representation of the total profile and the roughness profile of the surface topography of FIG. 6 taken in a horizontal orientation across the imagery of FIG. 6;

FIG. 10 is a graphical representation of the total profile and the roughness profile of the surface topography of FIG. 7 taken in a horizontal orientation across the imagery of FIG. 7;

FIG. 11 is a color microscopic image of Palmaria palmata propagules;

FIG. 12 is an SEM image of the first sample of a growth media of an embodiment of the disclosure, wherein the image is provided to-scale at the scale displayed in the image;

FIG. 13 is an SEM image of the second sample of a growth media of an embodiment of the disclosure, wherein the image is provided to-scale at the scale displayed in the image;

FIG. 14 is an SEM image of the third sample of a growth media of an embodiment of the disclosure, wherein the image is provided to-scale at the scaled displayed in the image;

FIG. 15 is a color photographic image of a surface of a growth media with false coloring portraying a catchment dispersion of immature seaweed plants on the first sample of a growth media of an embodiment of the disclosure;

FIG. 16 is a color photographic image of a surface of a growth media with false coloring portraying a catchment dispersion of immature seaweed plants on the second sample of a growth media of an embodiment of the disclosure;

FIG. 17 is a color photographic image of a surface of a growth media with false coloring portraying a catchment dispersion of immature seaweed plants on the third sample of a growth media of an embodiment of the disclosure;

FIG. 18 is a color photographic image portraying a catchment dispersion of immature seaweed plants on a portion of a growth media with selectively increased surface roughness compared to a portion of the growth media with relatively smooth surface roughness.

FIG. 19 is a color photographic image of a laid rope embodiment of the present invention formed by a loose twist of a strength fiber (shown in black) and a growth fiber (shown in white).

FIG. 20 is a color photographic image of a net formed from the laid rope embodiment of the present invention formed by a loose twist of a strength fiber (shown in black) and a growth fiber (shown in white).

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### DESCRIPTION OF VARIOUS EMBODIMENTS

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

The present disclosure relates to cultivation systems that include a growth media. The growth media is used for retention, culture, and/or growth of seaweed, and related methods and apparatuses. In some embodiments, the cultivation system is operable to grow seaweed in an open-water environment. In the present disclosure, the growth media may also be referred to as a growth fiber when the physical shape of the growth media is being referenced. The terms growth media and growth fiber are interchangeable herein.

Cultivation systems according to the instant disclosure can be used in spore culture and growth, and spore and/or gametophyte/sporophyte and/or fragmented seaweed material transport and deposition. In certain embodiments, the growth medias described herein can be used as an improved growth substrate for the growth and cultivation of seaweed forms (e.g., spores, gametophytes, sporophytes, fragmented seaweed material), resulting in improved yield and throughput relative to current cultivation practices.

Catchment is the initial entrapment of seaweed forms within the growth medium after initial seeding. Catchment is related to final biomass yields by initial seed density, seed uniformity, and seed spacing after outplanting. The key function of catchment is to provide protection, i.e., resistance to loss through dislodgement or seaweed forms until attachment, or holdfast formation, can provide sufficient stability for healthy plant growth to be initiated.

Seaweed form density and seaweed form spacing are related to optimum growth and final biomass yields, seaweed forms that are too close together or located in a dense area are less likely to attach and/or thrive due to the competition with surrounding plants for resources.

A holdfast is a root-like structure at the base of seaweed that fastens it to a substrate such as a stone, for example. Holdfasts differ in shape and structure between species. Substrate type can also affect holdfast shape and structure. Having no nutrient absorbent function, serving only as an anchor, seaweed holdfasts differ from the roots of land plants.

Effective biofouling protection is related to optimum growth and final biomass yields due to the reservation of resources for the target plants, as well as protection against predatory and/or parasitic organisms to provide ability for the target plant to thrive. Effective biofouling protection also supports harvest of the target plant as opposed to unintentional harvest of another species.

Surface energy describes the surface of a given substrate material in a way corresponding to the level of biofouling resistance of said substrate material. For example, the force of adhesion between foulants, e.g., epiphytes, that are present throughout seaweed cultivation on a growth media depends on the surface energy of the substrate. Foulants on a high surface energy substrate, i.e., hydrophilic materials, wet out the surface and form a strong bond onto the surface i.e., biofouling the surface. In contrast, materials with low surface energy, i.e., hydrophobic materials, resist wetting of foulants and produce much weaker adhesion between the foulants and the growth media. As such, these materials are considered to be biofouling resistant. However, materials with biofouling resistance due to low surface energy have also exhibited low catchment of seaweed spores and immature seaweed plants during the seeding process, limiting their potential improvement in seaweed cultivation yields despite the decreased biofouling.

In some embodiments, a plurality of seaweed spores are seeded onto the growth media, and those that are entrapped onto the growth media via catchment are allowed to develop into juvenile seedlings. In other embodiments, a plurality of juvenile seedlings (e.g., sporophytes and/or gametophytes) are seeded onto the growth media. In yet other embodiments, fragmented seaweed material is seeded onto the growth media. For purposes of the present disclosure, the use of the term immature seaweed plants will be used to refer to the different forms and stages of development of seaweed plants used in the seeding of the growth media, including seaweed spores, sporophytes, gametophytes, propagules and fragmented seaweed material. The plurality of seaweed spores and/or juvenile seaweed and/or fragmented seaweed material may all be of the same species, or of two or more different species. In some embodiments, two different seaweed species display a symbiotic relationship when cultured or grown together. In some embodiments, the seeded seaweed genus and/or variety may include, for example, one or more of Palmaria, Porphyra, Saccharina, Neopyropia, Gracilaria, Asparagopsis, kelp, and various red, green, and/or brown seaweeds.

In addition to retaining seaweed via catchment, cultivation systems and substrates of the instant disclosure can promote germination of and growth of seeded seaweed spores and growth of juvenile and mature seaweed. The growth media can, for example, create a microenvironment conducive to the germination and growth from the seeded seaweed spores and immature seaweed plants, and growth of juvenile and mature seaweed.

In certain embodiments, the growth media provides a selective nanostructure conducive to catchment and/or formation of holdfasts and subsequent growth of one or more target seaweed species while inhibiting or preventing attachment or growth of non-target species or other organisms. That is, the microstructure of the growth media supports catchment, attachment, and growth of seaweed species while inhibiting biofouling. In some embodiments, where biofouling species (e.g., non-target species or other organisms) do attach to the growth media, the attachment is weaker than that of the target seaweed species, and the biofouling species are removable by, for example, rinsing. In such embodiments, the physical removal of the biofouling species does not result in a significant dislodgement of the target species.

In some embodiments, the growth medias encourage quick and healthy growth of target species, allowing the target species to produce and secrete natural anti-fouling compounds before biofouling species are able to establish on the growth media. The target species thus, in addition to the growth media itself, contributes to anti-biofouling.

Good catchment and settlement are critical for the successful cultivation of seaweed crop; immature seaweed plants and juvenile plants must be caught and attached firmly enough as not to be separated from the growth media during exposure to the extreme conditions of the open ocean. All juvenile seaweed are prone to inhibition from biofouling, which is most often caused by an overgrowth of other algal species, such as diatoms, filamentous brown algae, and green algae. Biofouling issues are most prevalent at the farm site when first set out and when the immature seaweed plants and juvenile seaweed are small enough to be in danger of smothering, although biofouling can sometimes occur in the nursery during seed production. An ideal substrate would provide for secure catchment and attachment of target species, while discouraging growth of biofouling organisms.

In some embodiments, the microstructure of the growth media is configured to retain, by catchment, spores, fragmented seaweed material, and/or sporophytes, gametophytes, or other organisms grown from seaweed forms. In some embodiments, the microstructure is configured to retain, by catchment, algal sporophytes and/or gametophytes, plant spores, seedlings, bacterial endospores, fungal spores, fragmented seaweed material, or a combination thereof. In some embodiments, the growth media retains, via catchment, a plurality of spores, fragmented seaweed material, and/or organisms grown therefrom (e.g., sporophytes and/or gametophytes). The plurality of spores and/or organisms may all be of the same type, or of two or more different types. In some embodiments, the growth media retains seaweed spores and/or immature seaweed plants and/or seaweed of the same type that is seeded on the growth media. In other embodiments, the growth media retains seaweed spores and/or immature seaweed plants and/or seaweed of a different type than what is seeded on and attached to the growth media. In some embodiments, the growth media retains two different spore types that display a symbiotic relationship when cultured or grown together. For sake of simplicity, throughout this disclosure, reference will be made to “spores” in relation to the growth media, although fragmented seaweed material, gametophytes, sporophytes, seedlings, or other organisms grown from the spores are also contemplated by this term and are considered to be within the purview of the disclosure.

In some embodiments, in addition to retaining spores and/or immature seaweed plants, the growth media promotes attachment, germination of, and growth from the retained spores and/or immature seaweed plants. That is, the growth media viably maintains the retained spores and/or immature seaweed plants. In certain embodiments, the microstructure is configured to irremovably anchor at least a portion of a spore and/or immature seaweed plant.

In some embodiments, the growth media described herein includes a nutrient phase associated with at least a portion of the growth media. The nutrient phase serves to viably maintain spores, germinated spores retained by the growth media, and growing organisms (e.g., juvenile seaweed). In some embodiments, the nutrient phase promotes germination of and growth from retained spores and/or immature seaweed plants within the microstructure of the growth media. In some embodiments, the nutrient phase acts to maintain and/or encourage attachment to the growth media or maintain and/or encourage ingrowth into or integration within the microstructure of the growth media.

In some embodiments, the nutrient phase acts as a chemoattractant capable of attracting the spores and/or immature seaweed plants and/or juvenile organisms (e.g., seaweed sporophytes and/or gametophytes) to predetermined locations of the growth media to which the nutrient phase is applied or included.

The nutrient phase may be included within the growth media, on the growth media, or a combination thereof. In some embodiments, the nutrient phase is applied to a surface of the growth media as a coating. By encouraging growth of seaweed, the nutrient phase can assist in preventing biofouling, as healthy, quick-growing seaweed are known to produce and release their own natural antifouling compounds.

In some embodiments, the nutrient phase includes at least one nutrient beneficial to the target seaweed species and/or target spore and resulting germinated spore to be attached to or retained by the growth media. For example, where seaweed is attached to or retained by the growth media, the nutrient phase can include macronutrients (e.g., nitrogen, phosphorous, carbon, etc.), micronutrients (e.g., iron, zinc, copper, manganese, molybdenum, etc.), and vitamins (e.g., vitamin B₁₂, thiamine, biotin) that will support the growth and health of the germinated spore. The nutrients of the nutrient phase can be provided in various forms. For example, nitrogen can be provided as ammonium nitrate (NH₄NO₃), ammonium sulfate ((NR₄)₂SO₄), calcium nitrate (Ca(NO₃)₂), potassium nitrate (KNOB), urea (CO(NH₂)₂), etc. It will be recognized by those of skill in the art which nutrients would be beneficial to include in the nutrient phase so as to viably maintain the spores and resulting germinated spores and/or immature seaweed plants to be retained by the growth media.

Which nutrients to include in the nutrient phase will depend on which spores and/or immature seaweed plants are to be retained by the growth media, as various spore types, germinated spores, and growing organisms (e.g., seaweed) will have different nutrient needs. Nutrient selection may also depend on the intended use of the cultivation system. For example, where a growth media retaining spores, germinated spores, and/or growing organisms is to be introduced into an environment that is deficient in essential nutrients, all required nutrients can be included in the nutrient phase. Where a growth media retaining spores/germinated spores/growing organisms is to be introduced into an environment having at least one essential nutrient, those environmentally-available essential nutrients may be excluded from the nutrient phase or included at a lower concentration. The growth media may also act to concentrate nutrients from the environment by capturing the environmental nutrients in the growth media. This may be advantageous in environments where environmental nutrients are present only in low concentrations.

In some embodiments, the cultivation system can be used to transport retained spores/germinated spores from one location to another. Where the cultivation system functions as a transportation system, the nutrient phase may include sufficient nutrient levels to viably support the retained spores/germinated spores/growing organisms during transport. In some embodiments, the nutrient phase may include sufficient nutrient levels to viably maintain the retained spores/germinated spores/growing organisms post-transport, following introduction of the retained spores/germinated spores/growing organism into a new environment (e.g., the open water).

In some embodiments, the nutrient phase is formulated to control release rates of the nutrients.

In some embodiments, the growth media further comprises a salt associated with the growth media. In some embodiments, the salt is sodium chloride (NaCl). Salt associated with the growth media can produce and maintain a saline microenvironment for the retained spores/germinated spores/immature seaweed plants. This can be particularly advantageous when seaweed and marine plants are retained by the growth media. In some embodiments, a saline microenvironment within the growth media can be maintained when the growth media is submerged in fresh water, thereby viably maintaining marine species and avoiding the need to maintain a saline culture environment, which can be difficult and costly.

In some embodiments, the growth media includes a liquid-containing phase associated with at least a portion of the growth media. The liquid-containing phase serves to provide and maintain moisture within the microenvironment of the growth media, which may be beneficial to the viable maintenance of the spores/germinated spores/growing organism retained by the growth media.

In some embodiments, the growth media includes a liquid wicking material. The liquid wicking material functions to maintain moisture within the growth media's microenvironment.

While spores and endospores may be viably maintained in an arid environment, the germinated spores and growing organisms (e.g., juvenile seaweed) will generally require moisture to grow and/or proliferate. By maintaining a moist microenvironment (e.g., by including a liquid-containing substrate and/or a liquid wicking material), it may be possible to transport the culture system having spores/germinated spores/growing organisms retained therein and/or thereon without having to maintain the cultivation system in an aqueous environment.

In some embodiments, at least a portion of the growth media is hydrophilic. Such hydrophilic portions of the growth media may contribute to retention by the growth media and/or attachment to the growth media.

In some embodiments, at least a portion of the growth media is hydrophobic. Such hydrophobic portions of the growth media may reduce or prevent or resist retention and/or attachment of spores/germinated spores/growing organisms. This may help reduce or prevent biofouling and attachment of unwanted spores or other cells or organisms to the growth media.

In some embodiments, one or more portions of the growth media is hydrophobic, and one or more portions of the growth media is hydrophilic, such that spores/germinated spores/growing organisms are selectively encouraged to be retained by or attach to the one or more hydrophilic portions of the growth media.

In some embodiments, the growth media may include one or more bioactive agents associated with the growth media. Bioactive agents include any agent having an effect, whether positive or negative, on the cell or organism coming into contact with the agent. Suitable bioactive agents may include, for example, biocides and serums. Biocides may be associated with portions of the growth media to prevent attachment and growth of unwanted cells or organisms to those portions of the growth media. Unwanted cells may include non-target cells such as bacteria, yeast, and algae, for example (i.e., biofouling species). Biocides may also deter pests, such as insects. In some embodiments, the biocide prevents attachment and growth of the target spore to portions of the growth media where attachment and growth is not desired. In some embodiments, serums may be applied to portions of the growth media. Serums may aid in spore attachment and retention and/or encourage germination of or growth from the spore. Serums may include, for example, a source of growth factors, hormones, and attachment factors.

The growth media comprises a microporous material. In some embodiments, the growth media comprises an expanded thermoplastic polymer. In some embodiments, the expanded thermoplastic polymer forms the microstructure of the growth media. In some embodiments, the expanded thermoplastic polymer is selected from the group of expanded polyester sulfone (ePES), expanded ultra-high-molecular-weight polyethylene (eUHMWPE), expanded polylactic acid (ePLA), and expanded polyethylene (ePE).

In some embodiments, the growth media comprises an expanded fluoropolymer. The expanded fluoropolymer is selected from the group of expanded fluorinated ethylene propylene (eFEP), porous perfluoroalkoxy alkane (PFA), expanded ethylene tetrafluoroethylene (eETFE), expanded vinylidene fluoride co-tetrafluoroethylene or trifluoroethylene polymer (eVDF-co-(TFE or TrFE)), expanded polytetrafluoroethylene (ePTFE), and modified ePTFE. Examples of suitable expanded fluoropolymers include fluorinated ethylene propylene (FEP), porous perfluoroalkoxy alkane (PFA), polyester sulfone (PES), poly (p-xylylene) (ePPX) as taught in U.S. Patent Publication No. 2016/0032069, ultra-high molecular weight polyethylene (eUHMWPE) as taught in U.S. Pat. No. 9,926,416 to Sbriglia, ethylene tetrafluoroethylene (eETFE) as taught in U.S. Pat. No. 9,932,429 to Sbriglia, polylactic acid (ePLLA) as taught in U.S. Pat. No. 7,932,184 to Sbriglia, et al., vinylidene fluoride-co-tetrafluoroethylene or trifluoroethylene [VDF-co-(TFE or TrFE)] polymers as taught in U.S. Pat. No. 9,441,088 to Sbriglia.

In some embodiments, the growth media comprises an expanded polymer. In some embodiments, the expanded polymer forms the microstructure of the growth media. The expanded polymer may define spaces between polymer elements. In some embodiments, the expanded polymer is expanded polyurethane (ePU).

In some embodiments, the expanded polymer includes the nutrient phase. This may be achieved by co-blending the nutrient phase with the fluoropolymer resin prior to expansion of the polymer.

In some embodiments, the growth media comprises a polymer formed by expanded chemical vapor deposition (CVD). In some embodiments, the polymer formed by expanded CVD forms the microstructure of the growth media. In some embodiments, the polymer formed by expanded CVD is polyparaxylylene (ePPX).

In some embodiments, the growth media comprises a non-expanded microporous material. In some embodiments, the growth media comprises a sintered non-expanded microporous material produced by a thermoplastic polymer, for example, polyethylene or polypropylene. In some embodiments, the growth media comprises another non-expanded microporous material such as an open cell microporous polyurethane foam or sintered microporous polytetrafluoroethylene.

In some embodiments, the polymer establishing the growth media may form a membrane.

A microstructure of the growth media may be microporous, having opening or pore sizes of approximately 0.2 μm to approximately 200 μm. In some embodiments, the microstructure of the growth media may have a pore size of approximately 20.0 μm to approximately 100 μm.

The microstructure of the growth media may have a porosity of greater than approximately 50%. In some embodiments, the microstructure of the growth media may have a porosity of approximately 75% to approximately 97%. In some embodiments, the microstructure of the growth media may have a porosity of approximately 80% to approximately 97%. In some embodiments, the microstructure may have a porosity of approximately 90% to approximately 97%.

The microstructure of the growth media may have a bubble point of approximately 0.1 psi to approximately 32.0 psi. In some embodiments, the microstructure of the growth media may have a bubble point of approximately 0.1 psi to approximately 4.0 psi. In some embodiments, the microstructure of the growth media may have a bubble point of approximately 0.1 psi to approximately 3.0 psi. In some embodiments, the microstructure of the growth media may have a bubble point of approximately 0.1 psi to approximately 1.5 psi. The bubble point may be calculated as described further herein when the growth media is, for example, in the form of a membrane having a width. In some embodiments, the membrane may be twisted to form a yarn, rope, or braid to form the growth media. In such embodiments, the growth media may be undone to re-form a membrane, from which the bubble point may be calculated while accounting for damage.

The microstructure of the growth media may have a surface roughness having an average Ra value from approximately 1.0 μm to approximately 100 μm. In some embodiments, the surface roughness of the growth media may have an average Ra value from approximately 1.0 μm to approximately 50 μm. In some embodiments, the surface roughness of the growth media may have an average Ra value from approximately 2.5 μm to approximately 20 μm. In some embodiments, the surface roughness of the growth media may have an average Ra value from approximately 1.0 μm to approximately 3.0 μm. In some embodiments, the surface roughness of the growth media may have an average Ra value from approximately 2.5 μm to approximately 3.0 μm. In some embodiments, the microstructure of the growth media may have a surface energy of less than 35 dynes/cm.

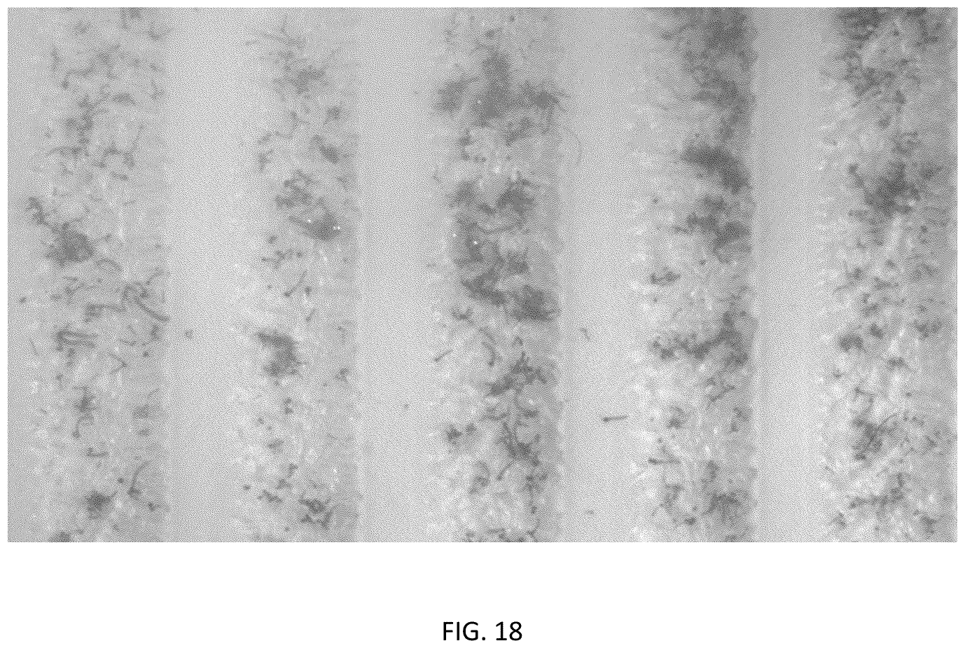

In some embodiments, the surface of the growth media may have portions exhibiting increased surface roughness and portions exhibiting low surface roughness. One of skill in the art would appreciate that varying the surface roughness allows for control of areas of catchment, which can allow for control of plant density. For example, as shown in FIG. 18, the portions of the growth media having increased surface roughness exhibit higher catchment of the immature seaweed plants and the portions of the growth media having low surface roughness exhibit lower catchment of the immature seaweed plants. While the pattern of high and low surface roughness may be in a regular line patter, as shown in FIG. 18, those skilled in the art would appreciate that a variety of pattern may be utilized, including checkerboard, weaves, or unequally-space lines.

In some embodiments, the growth media may be supported by a support structure. The growth media and the support structure may together form a composite. In some embodiments, the growth media may be braided, twisted, knitted, or weaved with the support structure. In some embodiments, the growth media is wrapped around or otherwise covers the support structure.

The support structure may be comprised of a polymer. In some embodiments, the polymer forming the support structure may comprise at least one of expanded fluorinated ethylene propylene (eFEP), porous perfluoroalkoxy alkane (PFA), expanded ethylene tetrafluoroethylene (eETFE), expanded vinylidene fluoride co-tetrafluoroethylene or trifluoroethylene polymer (eVDF-co-(TFE or TrFE)), expanded polytetrafluoroethylene (ePTFE), and modified ePTFE. Examples of suitable expanded fluoropolymers include fluorinated ethylene propylene (FEP), porous perfluoroalkoxy alkane (PFA), polyester sulfone (PES), poly (p-xylylene) (ePPX), ultra-high molecular weight polyethylene (eUHMWPE), ethylene tetrafluoroethylene (eETFE), polylactic acid (ePLLA), vinylidene fluoride-co-tetrafluoroethylene or trifluoroethylene [VDF-co-(TFE or TrFE)] polymers, expanded polyester sulfone (ePES), expanded ultra-high-molecular-weight polyethylene (eUHMWPE), expanded polylactic acid (ePLA), expanded polyethylene (ePE), expanded polyurethane (ePU), and polyparaxylylene (ePPX).

In some embodiments, the support structure may be comprised of a different polymer than the polymer forming the growth media.

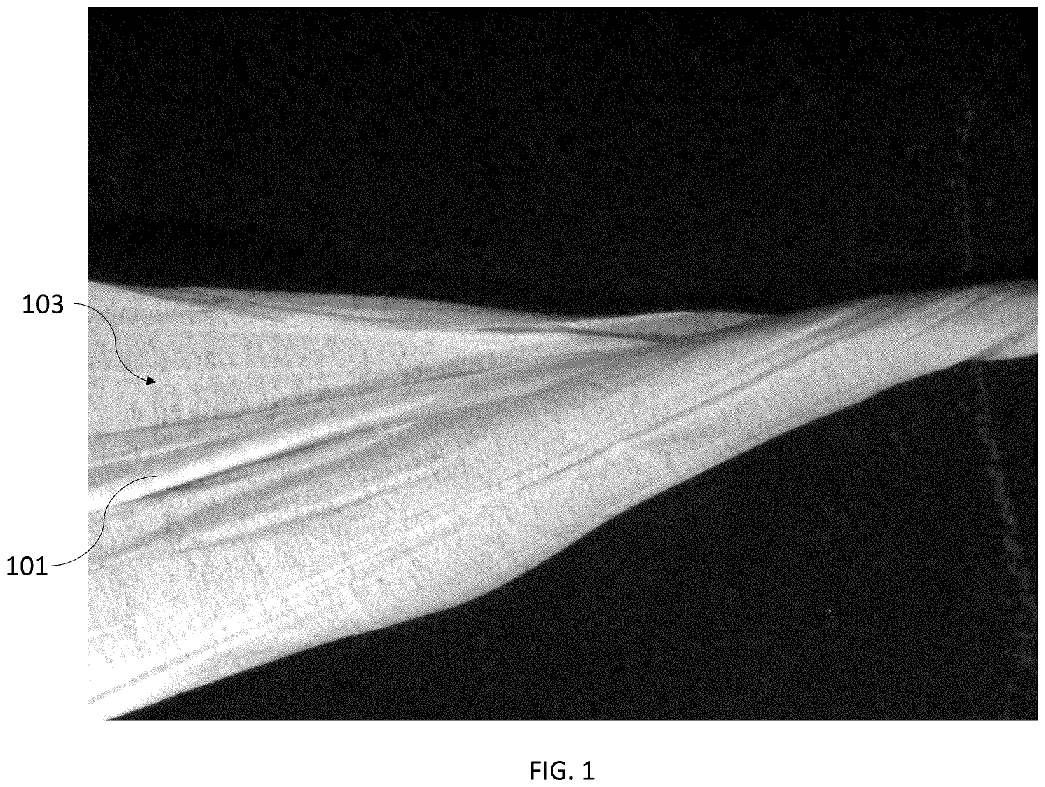

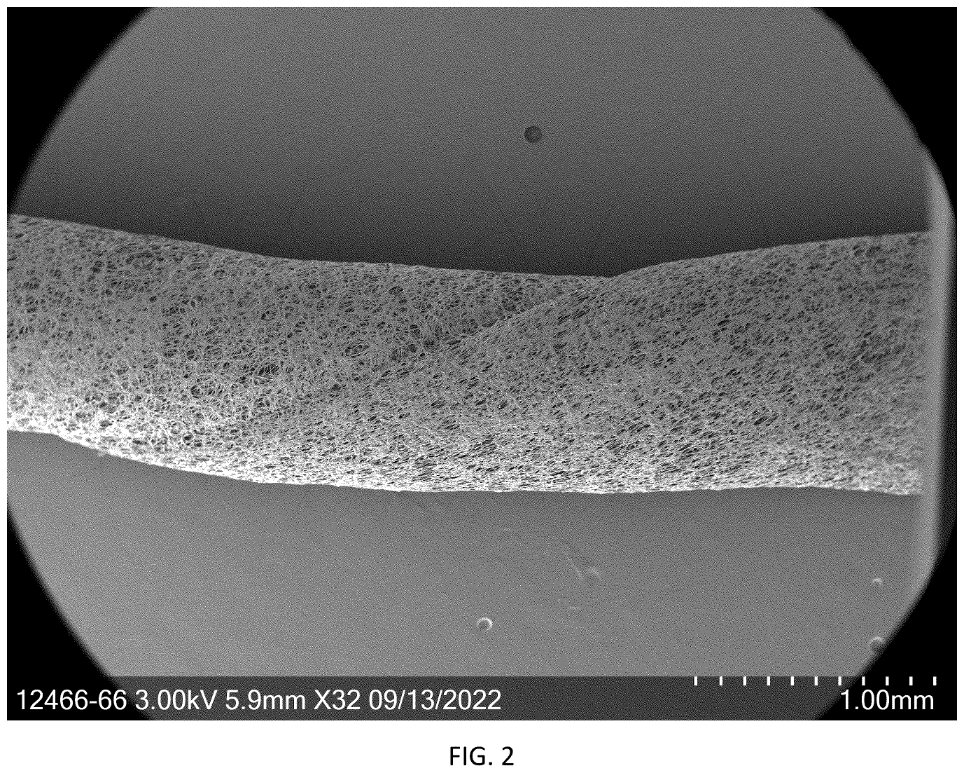

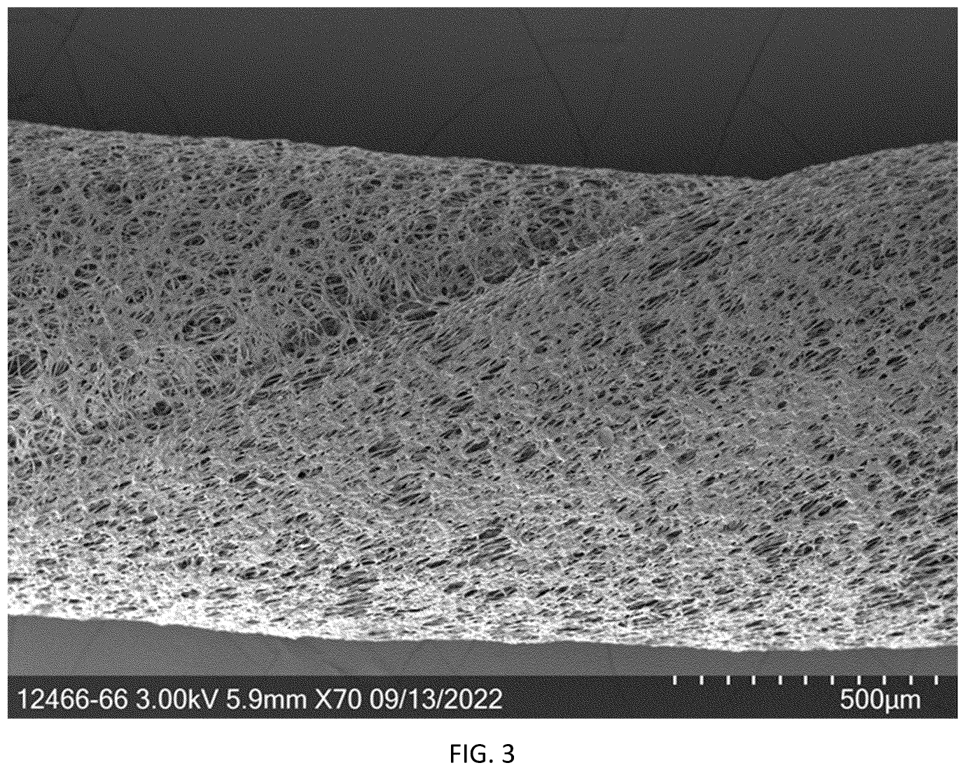

As mentioned above, in some embodiments, the growth media may be wrapped around a support structure to form a cultivation substrate. For example, referring to FIG. 1, the cultivation substrate may include a core support structure 101 with a growth media membrane 103 wrapped around the core support structure 101, as shown from left to right in FIG. 1. The resultant cultivation substrate is illustrated in FIGS. 2 and 3.

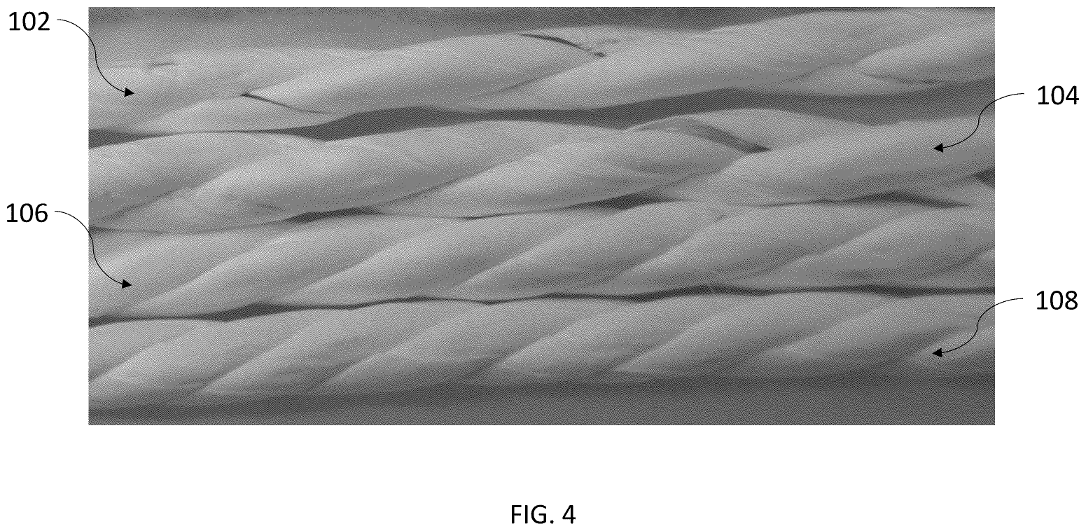

As mentioned above, in some embodiments, the growth media and the support structure may be twisted to form a cultivation substrate, as shown, for example, in FIG. 4. In some embodiments, the cultivation substrate may comprise twisted construction 102, including a 2-ply twist (also referred to as yarns) with each ply including three ends of polyethylene and three ends of monofilament polypropylene. In some embodiments, the cultivation substrate may comprise twisted construction 104, including a 2-ply twist with each ply including three ends of polyethylene, three ends of monofilament polypropylene, and three ends of spun polyester.

In some embodiments, the cultivation substrate may comprise twisted construction 106, including a 3-ply twist (also referred to as yarns) with each ply including two ends of polyethylene, two ends of monofilament polypropylene, and two ends of spun polyester. In some embodiments, the cultivation substrate may comprise twisted construction 108, including a 3-ply twist with each ply including two ends of polyethylene and two ends of monofilament polypropylene.

In some embodiments, the cultivation substrate may comprise twisted construction, including a 4-ply twist (also referred to as yarns) with each ply including a growth fiber of two ends of expanded polyethylene as the, a strength fiber of two ends of monofilament polypropylene, and a catchment fiber of two ends of spun polyester. In some embodiments, the cultivation substrate may comprise twisted construction, including a 4-ply twist with each ply including two ends of expanded polyethylene and two ends of monofilament polypropylene.

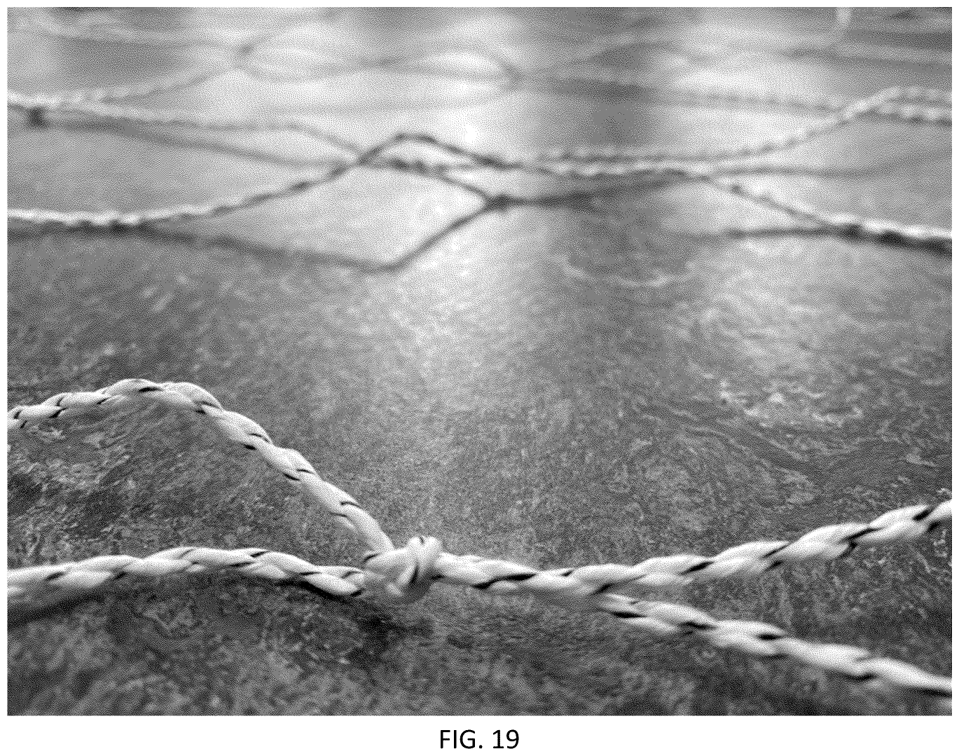

In some embodiments, the cultivation substrate may be in the form of a laid rope where one 2-ply, 3-ply, or 4-ply yarn of cultivation media, such as expanded polyethylene, is twisted together with a support media, such as monofilament polypropylene and/or spun polyester to form the yarn and then the yarn is twisted in the opposite direction with a second more 2-ply, 3-ply, or 4-ply yarn of cultivation media and support media to form a laid rope. The spun polyester may also be included to enhance catchment properties of the laid rope. Preferably the yarns are loosely twisted together to form a laid rope having more spaces between the two yarns, as shown in FIG. 19. As used herein with respect to the laid rope and yarns creating the laid rope, the terms “loose” and “loosely twisted” mean that two twisted fibers have the capacity to reorientate themselves from a first physical engagement to a second physical engagement that is similar to the first physical engagement. That definition can then further include a rolling engagement between twisted fibers, and further include an ability to disengage and reengage as the fiber moves between a taught state and a loose state.

For yarns and laid ropes described herein, the taughtness or looseness of the twist may be characterized in terms of the distance of the peak to trough of the groove formed by the angular relationship of the twisted fibers in relation to each other. For loosely twisted yarns herein, this distance is preferably typically about 50% of the diameter of a single ply and for the 2 ply construction, each ply is about 1.2 mm in diameter and the groove is 0.6 mm in distance from the top to bottom. Most preferably, the distance of the peak to the trough is about 0.5-1 mm or more.

This loose twisting allows more and deeper grooves to be formed between the points of contact of the two yarns along the length of the laid rope. These grooves provide additional areas for catchment and retention of spores, fragmented seaweed material, and/or sporophytes, gametophytes, or other organisms grown from seaweed forms.

In some embodiments, one or more laid ropes may be further combined to form other structures, such as a net or a loose woven material. The loosely twisted fibers and yarns of the laid rope allow for a rolling engagement between twisted fibers and between twisted yarns, and further include an ability to disengage and reengage as the fiber or yarn moves between a taught state and a loose state on portions of the twisted lines that are disposed between knots of the net.

The preferred structure of the laid rope used for the cultivation substrate will vary depending upon the species of algae cultivated. By way of illustration, it may be preferable to utilize the net form for cultivation of a smaller algae species, such as Palmaria, while a single (“long line”) laid rope may be preferable for a larger and faster growing species, such as Saccharina.

Adhesives, bioglues or binders are used to improve catchment and retention of seaweed spores and/or immature plants on traditional seaweed lines and strings. Such binders include hydrocolloid binders and viscosity-based hydrocolloid binders. As described further herein, the surface of the growth media of the embodiments described may lack adhesives, bioglues or binders to facilitate catchment.

In some embodiments, the cultivation systems described herein can be used in the farming of seaweed. During the seeding process, seaweed spores, fragmented seaweed material, immature seaweed plants, and/or other seaweed forms are introduced to a growth media. In some embodiments, the growth media is introduced to a solution or culture media comprising a plurality of spores and/or immature seaweed plants. In some embodiments, the growth media may be introduced to a fertile surrey prepared by placing a seaweed fragment in a bath and allowing natural release of spores. In some embodiments, a spore broth may be prepared by releasing seeds or other immature seed plants in a broth, which may allow for increased control of spores per square millimeter. The growth media of the presently described invention having desired properties for entrapping and viably maintaining the spores and/or immature seaweed plants via catchment until at least some of the spores germinate and are retained (i.e., attached) by the growth media. In some embodiments, the growth media can be incubated in a medium conducive to the germination of the spores and/or immature seaweed plants and growth of the germinated spores and/or immature seaweed plants. In other embodiments, the culture system itself provides a microenvironment conducive to the germination of spores and/or immature seaweed plants and growth of the germinated spores and/or immature seaweed plants, at least for a period of time (e.g., during temporary transport).

In some embodiments, the growth medias described herein can be used as a growth substrate for multicellular organisms from spores and/or immature seaweed plants. For example, the growth medias can be used to support growth of seaweed from spore and/or immature seaweed plant to mature seaweed. In some embodiments, the spore and/or immature seaweed plant that is to mature into the multicellular organism is contacted for a sufficient time and under predetermined conditions with a growth media, until at least some of the spores germinate and are retained by the growth media.

In some embodiments, seaweed spores and/or fragmented seaweed material and/or immature seaweed plants are introduced onto the growth media, and gametophytes and sporophytes are allowed to mature in a manner similar to traditional culture strings, by depositing the culture substrate (either with or without spores retained therein) on a rope, cable, or other support in the field, the traditional step of wrapping a culture string around a rope line can be skipped. This can be accomplished where the culture substrate is provided by an aqueous mixture of sporophytes and/or gametophytes.

In other embodiments, seaweed sporophytes and/or gametophytes and/or immature seaweed plants are directly introduced onto the culture substrate. Such direct seeding can reduce the laboratory time required to produce a culture string relative to spore seeding.

Culture strings are traditionally maintained and cultured in a laboratory environment using sterilized sea water. The culture strings, such as the culture media disclosed herein, are maintained in this environment for a period of time ranging from two weeks to eight weeks (e.g., an incubation period) to provide the immature seaweed plants the opportunity to securely attach to the culture media. The present cultivation systems, through inclusion of sufficient salt within the microstructure, circumvents the need for the expensive and cumbersome systems required for circulation of sterilized sea water by providing a saline microenvironment within the microstructure. In some embodiments, the seeded growth media is maintained in a standard seaweed cultivation tank, where nutrients are delivered via sterile seawater. By including a nutrient phase sufficient to support seaweed growth, the need to provide external nutrients to the growing seaweed may be obviated.

Generally, culture strings must be transported in sea water to the oceanic farming environment. Traditionally, this transport must be performed carefully to avoid jostling the culture strings to prevent gametophyte and sporophyte detachment from the string. The culture strings may be submerged into the oceanic farming environment about 2 to about 6 weeks after initial seeding. In some embodiments the culture string may be submerged into the oceanic farming environment about 2 to about 4 weeks after initial seeding. The presently described invention provides for less risk of detachment from the culture media due to the improved catchment and attachment of the immature seaweed plants.

### Test Methods

It should be understood that although certain methods and equipment are described below, other methods or equipment determined suitable by one of ordinary skill in the art may be alternatively utilized.

### Test Methods

An Ra value is defined by the average height or roundness of a surface, calculated by the deviation from a mean height. An Rz value is the difference between the tallest peak and the deepest valley of a surface. In determining the average Ra value and/or average Rz value of a material, samples were prepared in a way to minimize wrinkling and distortion of the material from its as-made form by cutting the samples from a larger piece of material, holding the samples taut, and taping the ends down when taking measurements using a profilometer, e.g., a Keyence VK-X1000 profilometer with a 404 nm violet semiconductor laser.

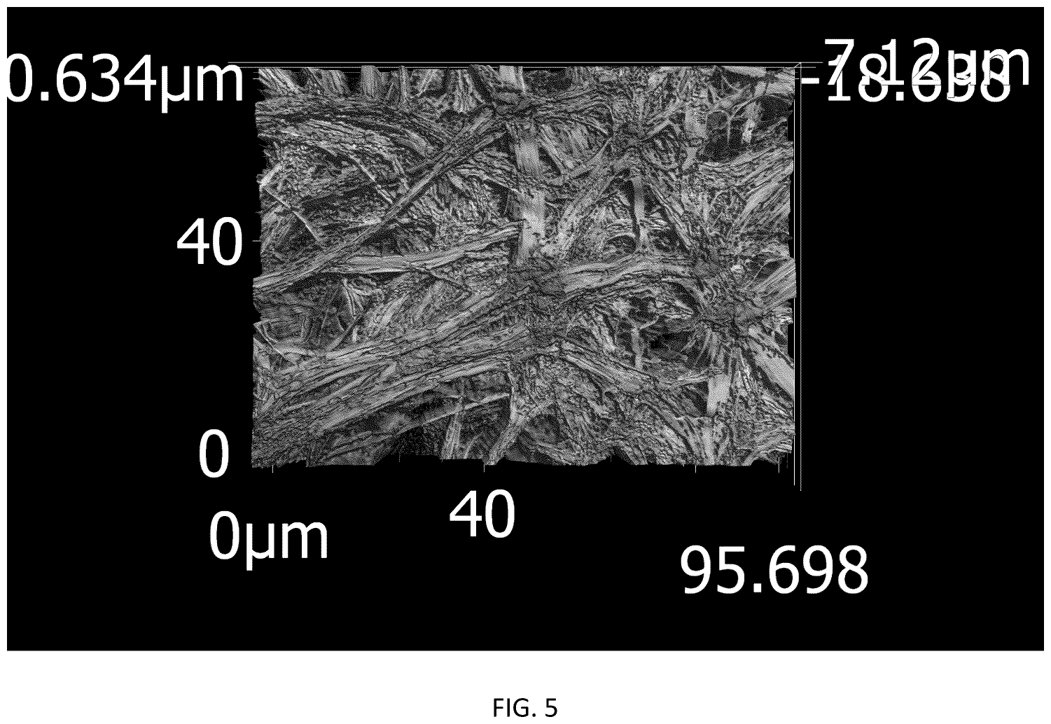

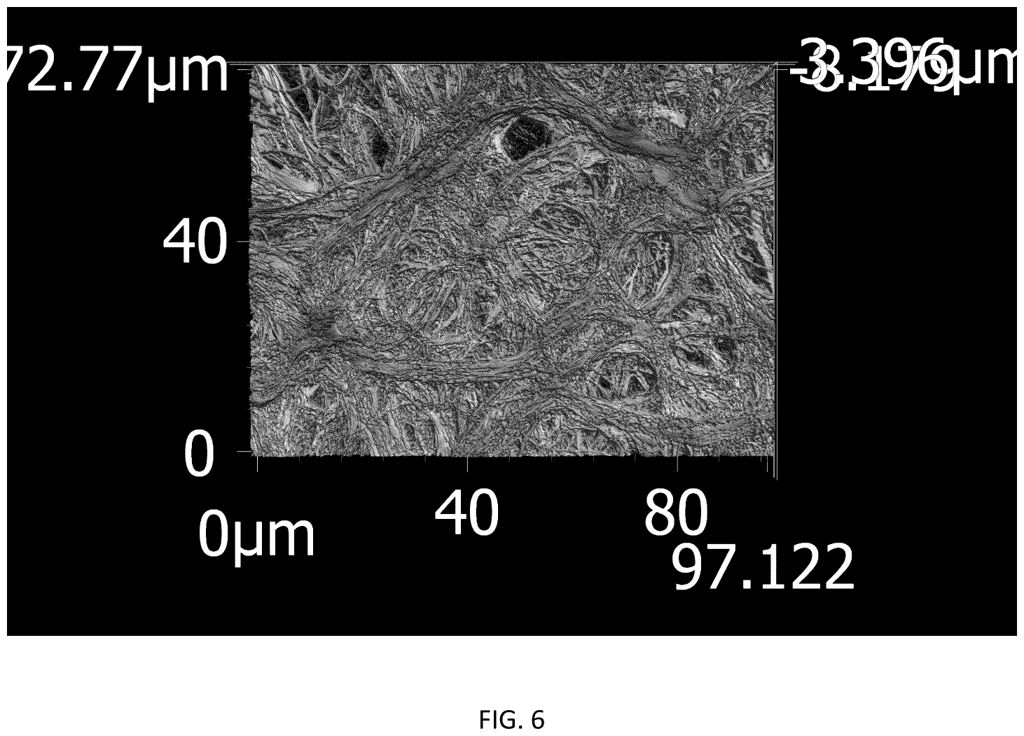

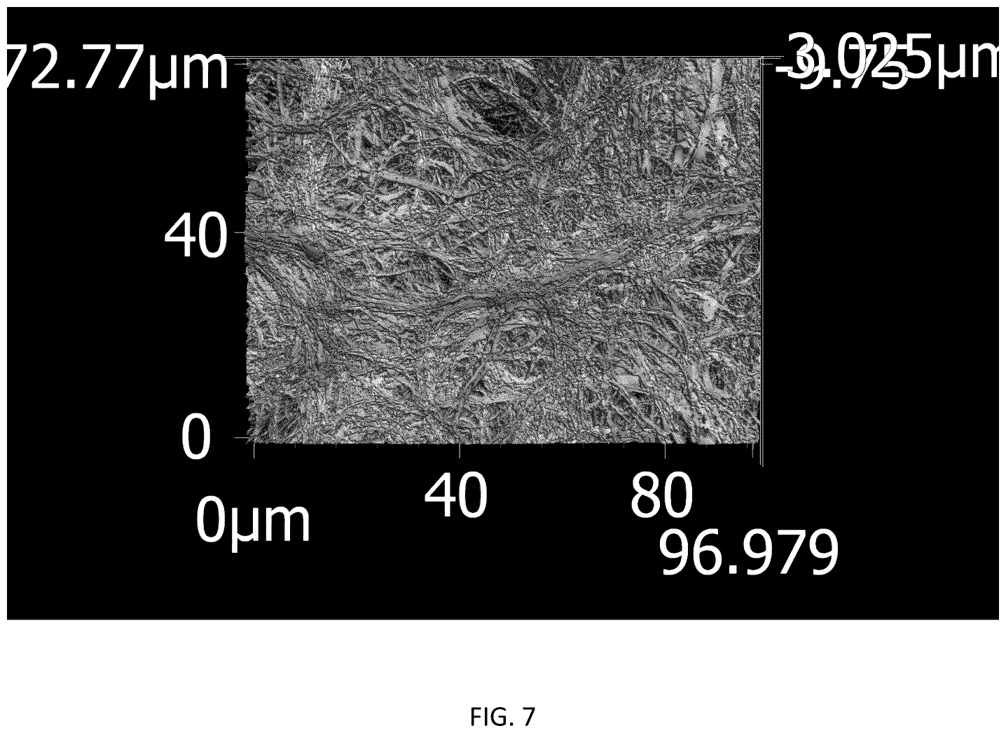

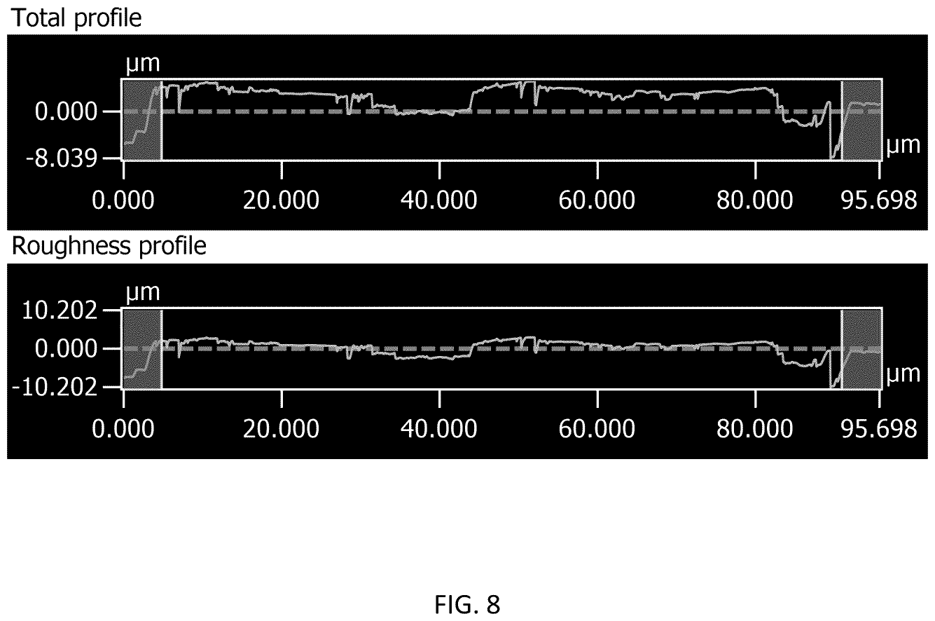

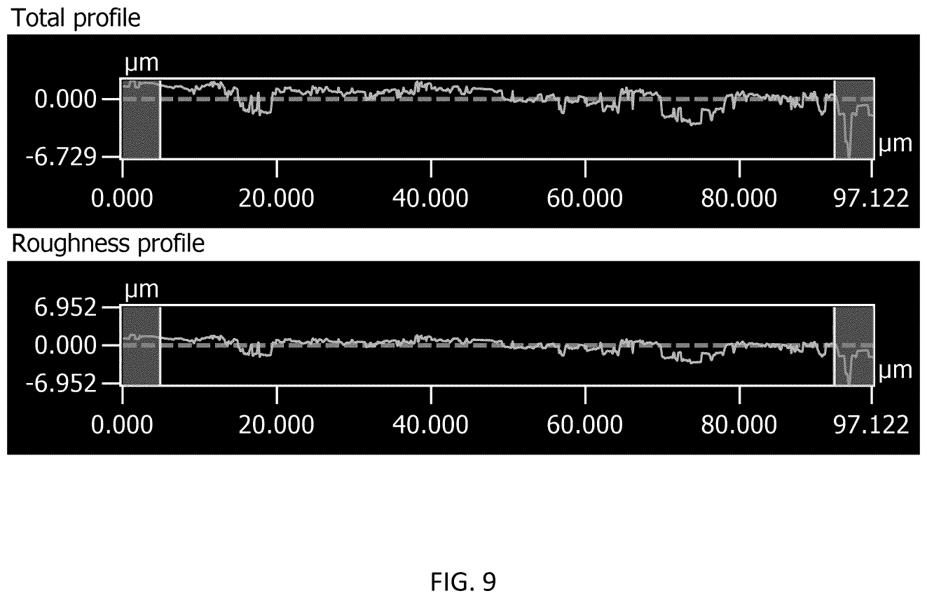

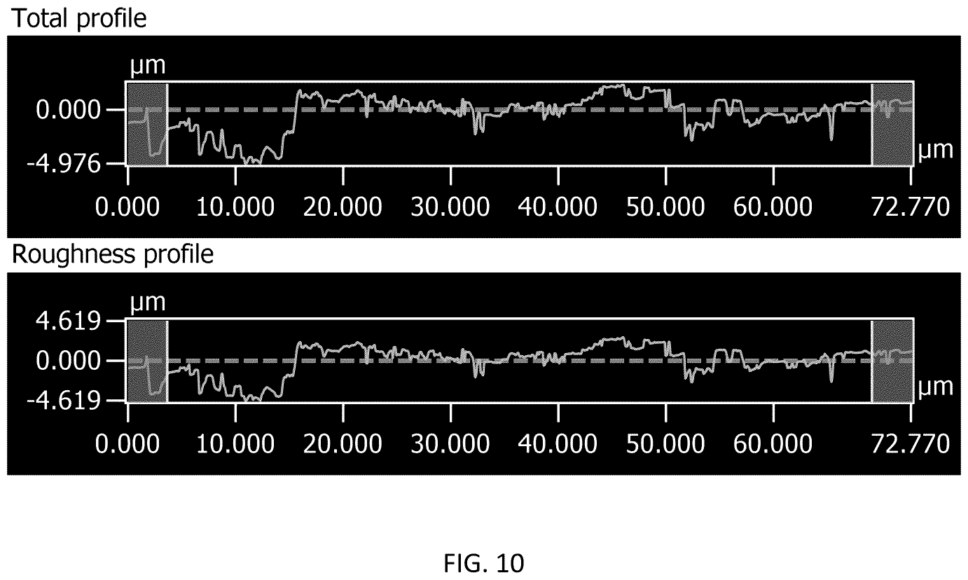

Raw data was captured from each sample using the “SuperFine” resolution setting of the profilometer, with a magnification of 150×, and, more specifically, a field of view of 97.169 μm. Tilt was removed by applying a reference plane, and wrinkles, or any other unintended large-scale features, were removed, only where necessary, via surface shape correction and waveform removal at a strength of 2. (see FIGS. 5, 6, and 7, pertaining to Samples A, B, and C, respectively, and as described further herein) Ra and Rz were then calculated by calculating the average Ra value of three horizontal and three vertical profile lines, which were captured by roughly splitting the image into quarters in both directions. Values presented in FIGS. 8, 9, and 10 for Samples A, B, and C, respectively, are the grand average of the horizontal and vertical average values. Ra and Rz were each determined using formulas according to ISO 21920-2:2021.

Pa is a measurement of the primary surface, including surface features such as waviness. Generally, Ra is removed from the Pa measurement per the ISO standards; however, because the sampling length was the same as the evaluation length, no further filters were applied per ISO 4288. As such, Ra is equal to Pa in these examples. Further information on the relationship between Ra and Pa can be found, for example, in “Correlating and evaluating the functionality-related properties with surface texture parameters and specific characteristics of machined components”, written by Quanren Zeng, et al., and published in International Journal of Mechanical Sciences, the entirety of which is hereby incorporated by reference (International Journal of Mechanical Sciences, 149 (2018) 62-72.

| Sample ID | Mean Ra (um) | Mean Rz (um) |
|---|---|---|
| A | 2.537 | 17.055 |
| B | 1.105 | 7.845 |
| C | 0.856 | 6.188 |
| A in Fiber Form | 2.559 | 15.432 |

Surface energy is calculated via contact angle measurements. The contact angle is measured through sessile drop measurements with an optical tensiometer. Pure liquids with known surface tension values (e.g., water) are used for these measurements, and their measured contact angles (advancing and receding) with the test surface are then used to calculate the surface energy. In some embodiments, and, in particular, embodiments using powders, particulates, fibers, or films, Inverse Gas Chromatography and related techniques are used for surface energy measurements. A series of solvent pulses are injected through a column containing the sample of interest and from the resulting vapor adsorption isotherms, the surface energy can be accurately determined.

Porosity is a measure of the voids, pores, or empty spaces in a material. Porosity is calculated as a percentage of the volume of the voids over the total volume. Typical techniques to determine porosity are helium pycnometry and mercury porosimetry.

The bubble point was measured according to the general teachings of ASTM F316-03 using a Capillary Flow Porometer (Model 3G zh from Quantachrome Instruments). The sample holder included a porous metal plate (Part Number 196450, Anton Paar) having a 25.4 mm diameter and a plastic mask (Part Number ABF-300, Professional Plastics), having an 18 mm inner diameter and a 24.5 mm outer diameter. The sample was placed between the metal plate and the plastic mask and then clamped down and sealed using an O-ring (Part Number 193798, Anton Paar). The sample was then wetted with the test fluid, i.e. Silicone fluid, 10 cSt, having a surface tension of 19.75 dynes/cm.

The maximum pore size diameter was calculated from the Young-Laplace equation using the bubble point with the following equation:

$$Maximum pore size diameter ( micron ) = \frac{4 * ( surface tension of fluid ) ( dyne / cm ) * cos ( contact angle )}{bubble point pressure ( psi )}$$

It is assumed that there is complete wetting of the fluid into the membrane and the contact angle is zero, so that the equation becomes:

$$Maximum pore size diameter ( micron ) = \frac{11.455}{bubble point pressure ( psi )}$$

### EXAMPLES

### Example 1

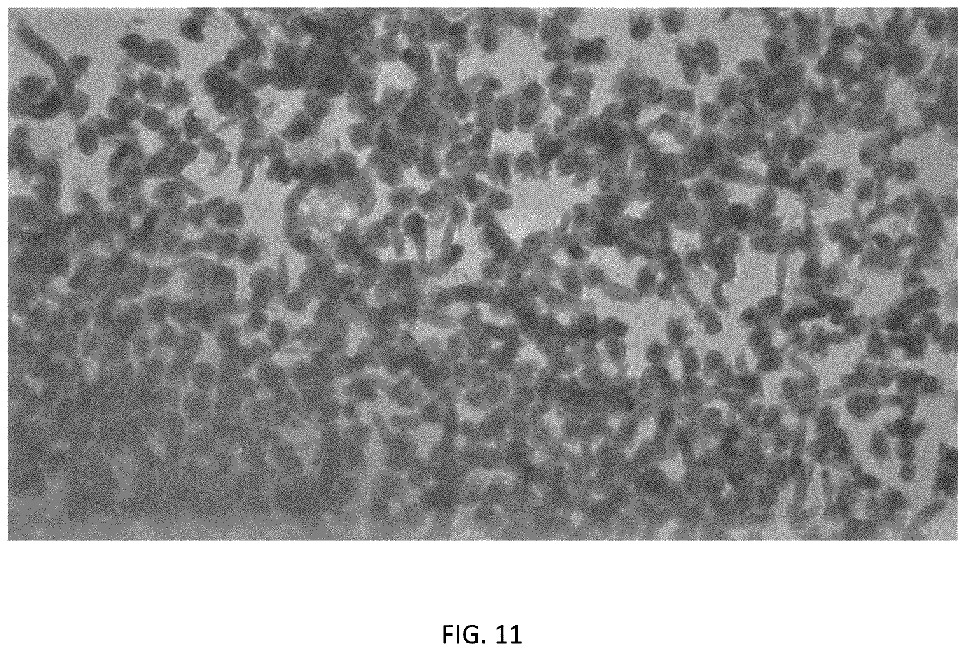

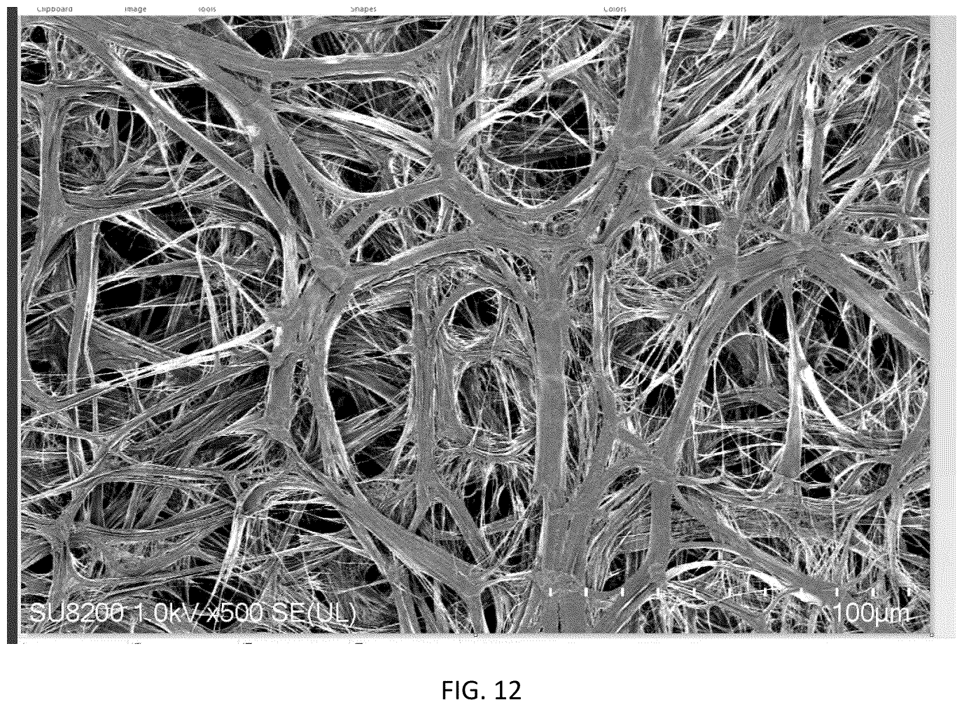

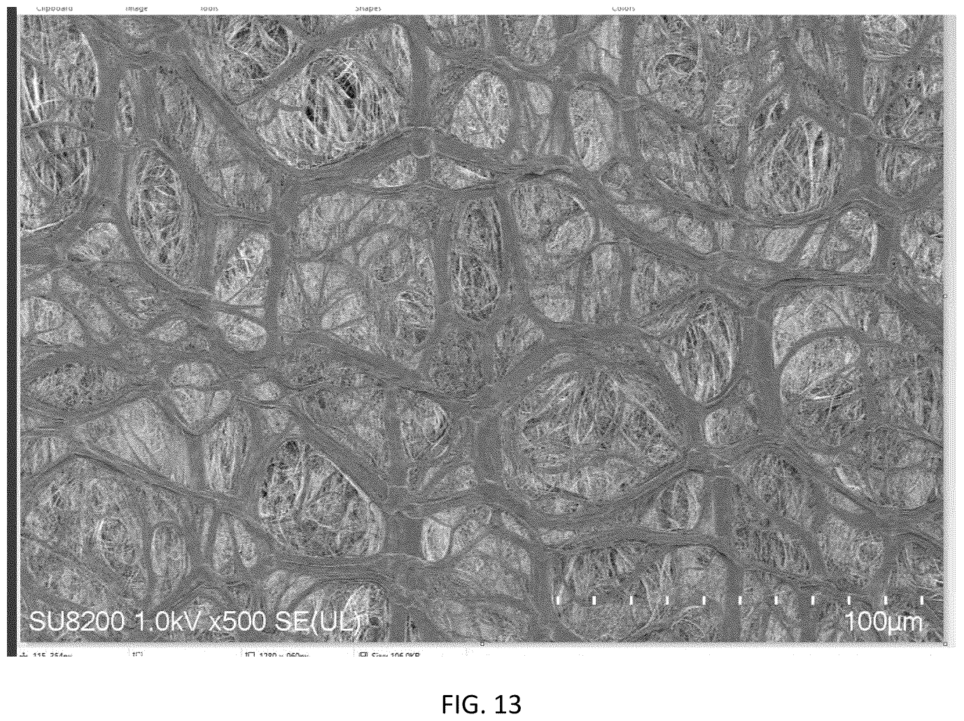

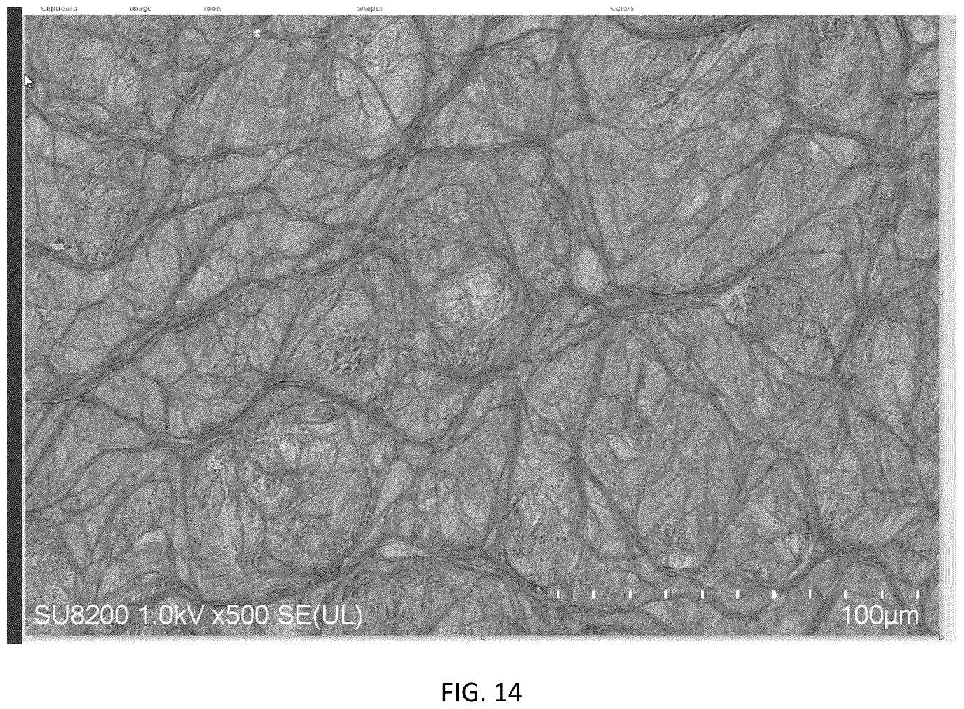

Palmaria palmata propagules (i.e., germinating gametophytes and spores as seen in FIG. 11) were seeded onto three samples of polyethylene: Sample A (FIG. 12), Sample B (FIG. 13), and Sample C (FIG. 14). Sample A exhibited the following characteristics: an Ra value of 2.5 μm; a thickness of 90 μm; 94% porosity; an average pore size of 23 μm; a bubble point of 0.5 psi; and a matrix tensile strength of 3351/7912 psi. Sample B exhibited the following characteristics: an Ra value of 1.1 μm; a thickness of 104 μm; 84% porosity; an average pore size of 2 μm; a bubble point of 4.9 psi; and a matrix tensile strength of 8768/12998 psi. Sample C exhibited the following characteristics: an Ra value of 0.9 μm; a thickness of 17 μm; 78% porosity; an average pore size of 0.4 μm; a bubble point of 24.3 psi; and a matrix tensile strength of 13193/26115 psi.

Three replicates were prepared for each sample, which were fixed around a glass slide and placed horizontally on the bottom of square tanks with three central aligned aeration points. To estimate the catchment number for each sample, image analyses of fixed-sized photo fields were used to count the total number and area of settled propagules in square micrometers on all samples 13 days after the initial seeding.

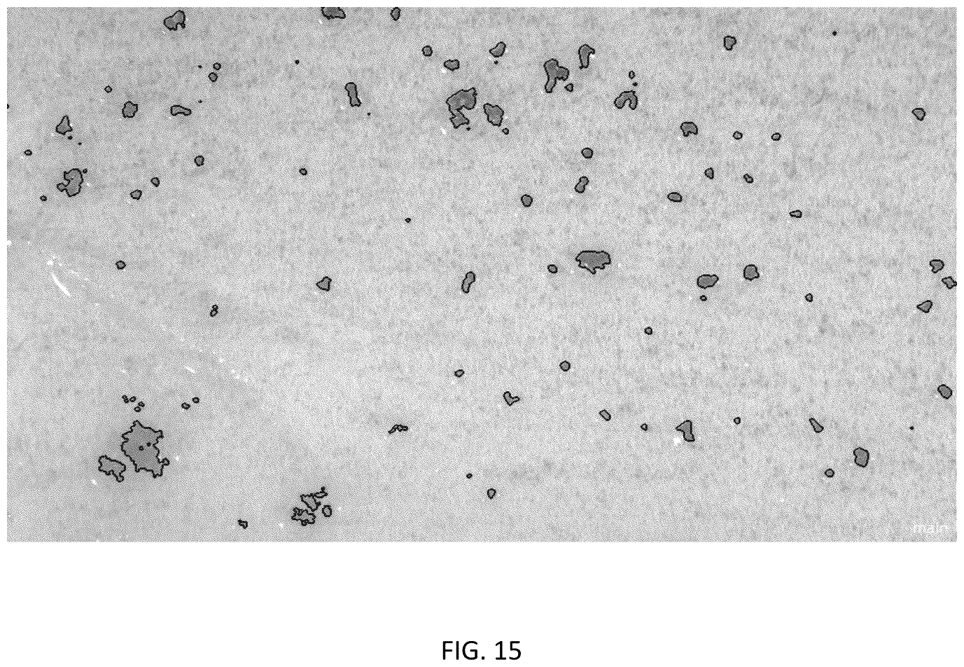

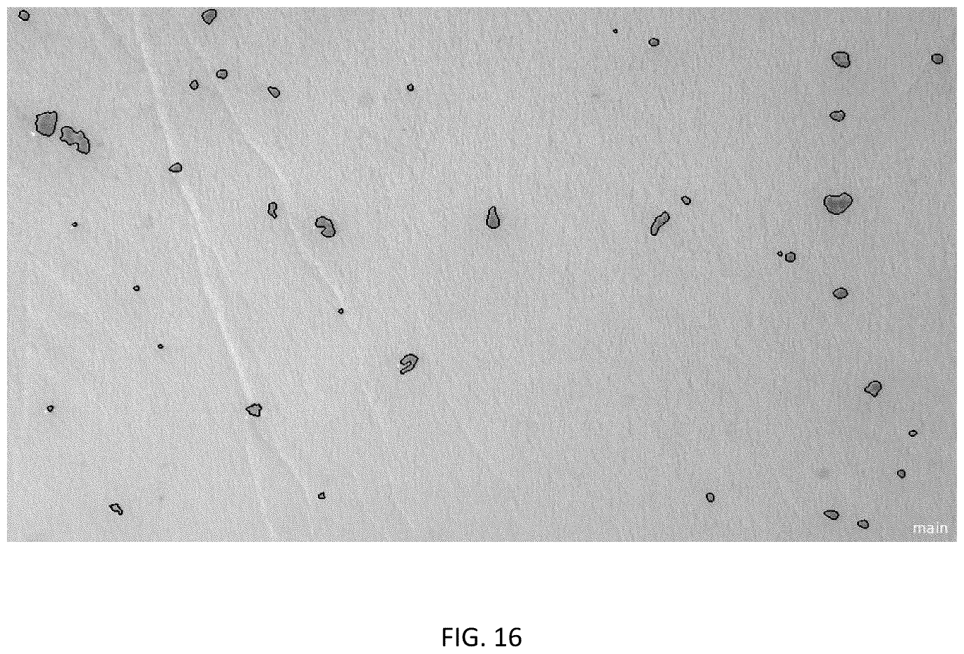

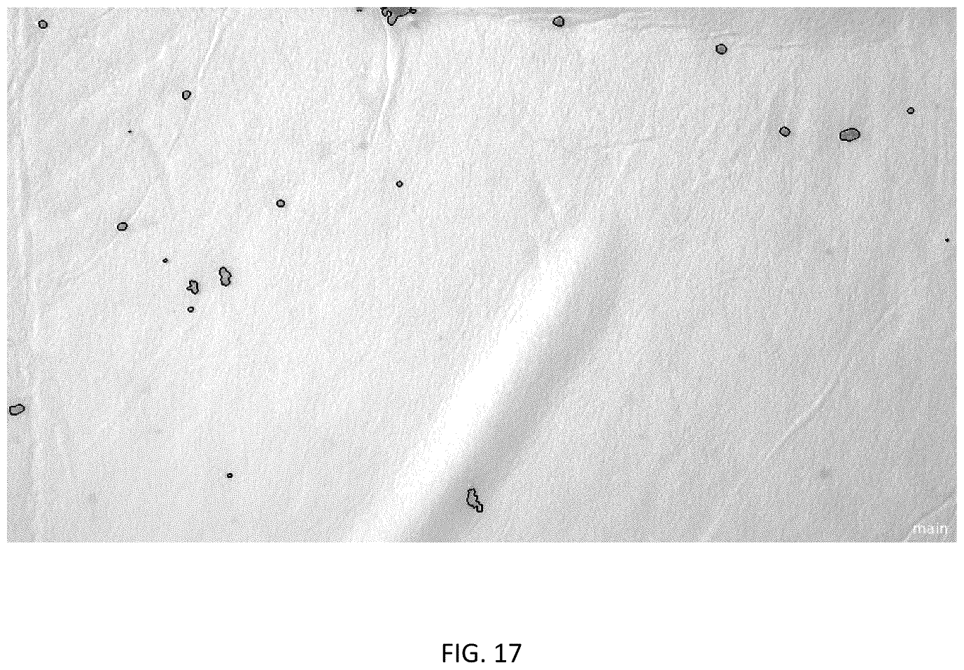

As shown in FIG. 15, Sample A exhibited a mean catchment (i.e., total number of seeds in photo field) of 82.7 seeds. The mean catchment area in the photofield was 1201200 μm². As shown in FIG. 16, Sample B exhibited a mean catchment of 27.7 seeds. The mean catchment area in the photofield was 354240 μm². As shown in FIG. 17, sample C exhibited a mean catchment of 17.7 seeds. The mean catchment area in the photofield was 202752 μm². As demonstrated, Sample A exhibited a significantly higher mean catchment (i.e., total number of seeds) and mean catchment area values relative to Sample B and Sample C.

### Example 2

Palmaria palmata propagules (i.e., germinating gametophytes and spores) were seeded onto a microporous expanded Polytetrafluoroethylene material having a plurality of adjacent lanes of varying surface textures. The sample was fixed around a glass slide and placed horizontally on the bottom of square tanks with three central aligned aeration points. The sample was monitored for three days after seeding. As shown in FIG. 18, retainment of the propagules correlated with the rougher surface texture areas of the sample.

### Example 3

A concentrated solution of 42,480,000 Saccharina latissimi zoospores was diluted with autoclaved seawater to achieve a final density of 10 zoospores per square millimeter. Microporous expanded polyethylene samples, i.e., Sample A, Sample B, and Sample C, were chose for testing and compared to a non-woven fibrillated polytetrafluoroethylene material (“Sample E”) and a non-woven melt spun silk-based material (“Sample F”).

Sample A exhibited the following characteristics: an Ra value of 2.5 μm; a thickness of 90 μm; 94% porosity; an average pore size of 23 μm; a bubble point of 0.9 psi; and a matrix tensile strength of 3351/7912 psi. Sample B exhibited the following characteristics: an Ra value of 0.9 μm; a thickness of 104 μm; 84% porosity; an average pore size of 2 μm; a bubble point of 3.4 psi; and a matrix tensile strength of 8768/12998 psi. Sample C exhibited the following characteristics: an Ra value of 0.5 μm; a thickness of 17 μm; 78% porosity; an average pore size of 0.4 μm; a bubble point of 30.6 psi; and a matrix tensile strength of 13193/26115 psi.

Swatches of each material were adhered to a polycarbonate backing panel using a cyanoacrylate glue and left for 24 hours. Each sample included 4 replicate swatches. The panels were then dipped in a 100% ethanol solution for 15-20 seconds. The alcohol wash enhanced the wettability of the samples while also removing contaminates from the swatches. The panels were then immediately rinsed twice with distilled water. The panels were individually placed in a container with 170 mL of autoclaved seawater. Each container included a 4 mm hole positioned on a lateral wall approximately 5 mm above the bottom rim to minimize water movement within the container and allow for undisturbed settlement, as well as facilitate gas exchange with the water with minimal disturbance to the samples.

Seeding solution (10 mL) was added to each container and gently mixed to ensure an even settlement over a 24-hour period. The containers containing the samples were left undisturbed for 7 days, during which the water temperature ranged from 9-13° C. and light was provided for 12 hours per day so that each container received light with photosynthetic active radiation values 20-30 μmol s⁻¹ m⁻².

To assess catchment, the four replicate swatches for each sample were removed and fixed to a support so that the panels formed a continuous surface along the length of the support. The support was inverted and fixed within a 3.5 m biological flume so that the continuous surface was oriented along the primary flow axis. The flume was supplied with 50 μm filtered seawater at a rate of 2 l/min to a total volume of 690 litres. The flume was used to simulate the water currents a growth media would be exposed in an oceanic farming environment. Catchment was considered successful when 30% or more of seed was retained on the material after a 24-hour exposure to the water flow velocity. Water flow velocity was measured using an acoustic doppler velocimeter.

After twenty-four hours of flume exposure, the panels were removed from the flume, immersed in filtered seawater, and transferred to a microscope, where the panels were then mounted and imaged. While the images represented a 2-D caption of the samples, the zoospores were also distributed along the Z-axis, which was considered during imaging. Imaging was then repeated a week later. An image processing and analysis program was used to determine the zoospore density on each panel immediately following flume exposure and again the 7 days following flume exposure.

Immediately following flume exposure, Sample A had a spore density of 9.25 spores/mm², i.e., 92.5% spore retention; Sample B had a spore density of 4.79 spores/mm², i.e., 47.9% spore retention; Sample C had a spore density of 7.04 spores/mm², i.e., 70.4% spore retention; Sample E had a spore density of 0.21 spores/mm², i.e., 2.1% spore retention; and Sample F had a spore density of 0 spores/mm², i.e., 0% spore retention.

At the 7-day mark, Sample A had a spore density of 8.02 spores/mm², i.e., 80.2% spore retention; Sample B had a spore density of 4.63 spores/mm², i.e., 46.3% spore retention; Sample C had a spore density of 6.58 spores/mm², i.e., 65.8% spore retention; Sample E had a spore density of 0.10 spores/mm², i.e., 1.0% spore retention; and Sample F had a spore density of 0 spores/mm², i.e., 0% spore retention.

All materials were seeded using a spore density of approximately 10 individual spores per mm² surface area. Sample A had spore densities immediately following flume exposure and on day 7 that were close to the density at which it was seeded (92.5% and 80.2% retention, respectively). In contrast, the non-woven materials tested showed a very low retention of spores (1.0%-2.1% and 0%) post-flume exposure, indicating poor catchment.

### Example 4

A 2-liter culture, previously blended and passed through a filter to remove large material, containing an average of 5522 individual Saccharina latissima gametophytes per milliliter was prepared. A microporous expanded polytetrafluoroethylene material with a coarse roughened surface (“Sample G”) was cut into swatches and adhered to a polycarbonate backing panel using cyanoacrylate glue and left for 24 hours. The panel was dipped in a 100% ethanol solution for 15-20 seconds to enhance the wettability of the material while also removing any contaminates. The panel was rinsed twice with distilled water immediately following the alcohol wash.

A pneumatic spray nozzle apparatus was arranged in a vertical orientation 50 mm from a flat seeding surface. The panel was loaded onto the surface and made four separate passes, each lasting approximately 1 second, under the pneumatic spray nozzle apparatus, which distributed media at a flow rate of approximately 2.3 mL s⁻¹. The panel received approximately 9.2 mL of media and approximately 50,000 gametophyte fragments contained within a fine aerosol high pressure spray.

Three groups of panels were prepared, a first group to be analyzed at day 0, a second group to be analyzed at day 7, and a third group to be analyzed at day 14. Each group of panels were replicated for each test condition, including swatches with no binder, swatches with a celled hydrocolloid binder A, and swatches with a viscosity-based hydrocolloid binder B, with each test condition further receiving four replicated panels. Panels receiving a binder did so immediately after spray seeding, and all day 0 panels were imaged immediately, while day 7 and day 14 panels were stored in a room maintained at 10° C. and subsequently removed and imaged at the corresponding 7 or 14 days later. All samples (including replicates) at day 0, 7, and 14 were tested independently, e.g., samples at day 7 were not used for testing at day 14.

To quantify catchment, each panel was transferred in trays immersed with filtered seawater to prevent desiccation. Prior to imaging, the panels were transferred to a sterile square petri dish and fully immersed in filtered seawater so that the meniscus of the liquid exceeded the depth of the plate and mounted material. The petri dish was mounted below a dissection microscope and the panel was illuminated with two sets of cold light sources. Two images were taken of each replicate. Determination of field of view of the images was random, ensured by letting the plate settle naturally in the petri dish of filtered seawater and adjusting orientation prior to viewing the image capture window. The first image was taken at 20× magnification and the second image was taken at 40× magnification. Adjustments were made to ensure representative coverage of the material. An image processing and analysis program was used to determine the gametophyte seed density (mm² per mm² surface area) for the 0-, 7-, and 14-day samples.

Panels with no binder had an average seed coverage of 0.00836 mm² per mm² at day 0, 0.00436 mm² per mm² at day 7 (52% retention from day 0), and 0.00702 mm² per mm² at day 14 (84% retention from day 0). Panels with binder A had an average seed coverage of 0.00442 mm² per mm² at day 0, 0.00017 mm² per mm² at day 7 (3.8% retention from day 0), and 0.00003 mm² per mm² at day 14 (0.6% retention from day 0). Panels with binder B had an average seed coverage of 0.00688 mm² per mm² at day 0, 0.00061 mm² per mm² at day 7 (8.9% retention from day 0), and 0.00099 mm² per mm² at day 14 (14.4% retention from day 0).

The panels with no binder showed significantly higher catchment retention after 7 and 14 days relative to panels using binders A or B.

As shown in FIG. 19, the cultivation substrate may be in the form of a laid rope. In one example, the laid rope is formed from 2-ply yarns created by twisting microporous fiber of denier 2400 of Sample A (having the characteristics described above: an Ra value of 2.5 μm; a thickness of 90 μm; 94% porosity; an average pore size of 23 μm; a bubble point of 0.9 psi; and a matrix tensile strength of 3351/7912 psi) with 6×595 denier ends of monofilament polypropylene. This resulted in a laid rope of average diameter 2.2 mm and average break strength of 74 lbs.

In another example, the laid rope is formed from 3-ply yarns created by twisting microporous fiber of denier 2400 of Sample A (having the characteristics described above: an Ra value of 2.5 μm; a thickness of 90 μm; 94% porosity; an average pore size of 23 μm; a bubble point of 0.9 psi; and a matrix tensile strength of 3351/7912 psi) with 2×595 denier ends of monofilament polypropylene and 5×850 denier ends of spun polyester resulting in a yarn of average diameter 2.0 mm and average break strength of 98 lbs.

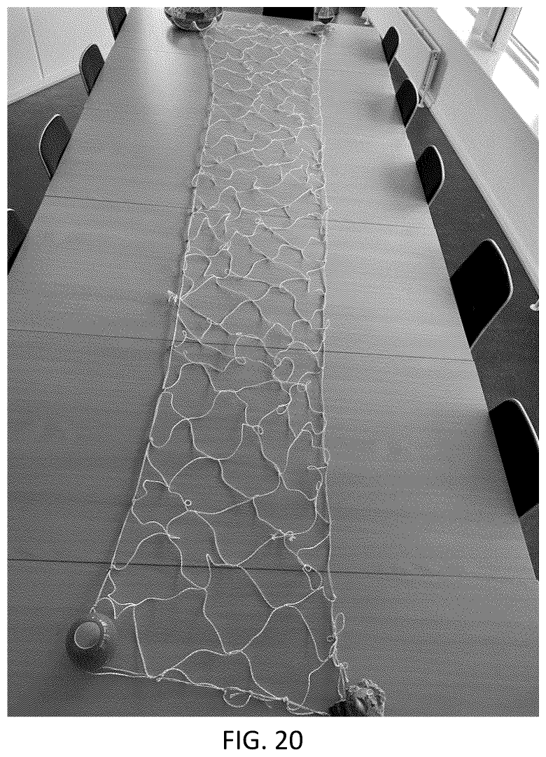

As shown in FIG. 20, the laid rope is knotted to construct a 4 m×1 m net consisting of diamond shaped openings each of length 35 cm and width of 15 cm.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A seaweed cultivation system for use in an aquatic environment, the system comprising:
a support structure; and
a microporous growth media supported by the support structure, the microporous growth media having a catchment surface,
wherein the catchment surface has a surface roughness having an average Ra value inclusively ranging from 1.0 μm to 50 μm.

2. The seaweed cultivation system of claim 1, wherein the surface roughness having an average Ra value inclusively ranging from 2.5 μm to 20 μm.

3. The seaweed cultivation system of claim 1, wherein the catchment surface of the microporous growth media has a bubble point inclusively ranging from 0.1 psi to 3.0 psi.

4. The seaweed cultivation system of claim 1, wherein the microporous growth media has a plurality of openings distributed across at least a portion of the catchment surface, the plurality of openings defining an average opening size inclusively ranging from 5 microns to 200 microns.

5. The seaweed cultivation system of claim 4, wherein the plurality of openings defines an average opening size inclusively ranging from 20 microns to 100 microns.

6. The seaweed cultivation system of claim 1, wherein the microporous growth media has a porosity inclusively ranging from 50% to 90%.

7. The seaweed cultivation system of claim 1, wherein the microporous growth media is a polymer.

8. The seaweed cultivation system of claim 7, wherein the polymer forms a membrane.

9. The seaweed cultivation system of claim 7, wherein the polymer is an expanded polymer defining spaces between polymer elements.

10. The seaweed cultivation system of claim 9, wherein the polymer is selected from the group consisting of expanded fluorinated ethylene propylene (eFEP), porous perfluoroalkoxy alkane (PFA), expanded ethylene tetrafluoroethylene (eETFE), expanded vinylidene fluoride co-tetrafluoroethylene or trifluoroethylene polymer (eVDF-co(TFE or TrFE)), expanded polytetrafluoroethylene (ePTFE), and expanded polyethylene (ePE).

11. The seaweed cultivation system of claim 10, wherein the polymer is ePE.

12. The seaweed cultivation system of claim 1, wherein the support structure and the growth media together form a composite.

13. The seaweed cultivation system of claim 12, wherein the support structure of the composite is a polymer.

14. The seaweed cultivation system of claim 13, wherein the support structure comprises a different polymer than the microporous growth media polymer.

15. The seaweed cultivation system of claim 1, wherein the catchment surface is free of adhesive, bioglue, or binder.

16. The seaweed cultivation system of claim 1, wherein the microporous growth media is formed as a yarn, a rope, or a braid.

17. The seaweed cultivation system of claim 1, wherein the microporous growth media is braided, twisted, knitted, or weaved with the support structure.

18. The seaweed cultivation system of claim 1, wherein the catchment surface has a surface energy of less than 35 dynes/cm.

19. The seaweed cultivation system of claim 1, further comprising a plurality of immature seaweed plants engaging the catchment surface.

20. The seaweed cultivation system of claim 19, wherein the plurality of immature seaweed plants comprises seaweed spores, gametophytes, sporophytes, propagules or fragmented seaweed plants.

21. The seaweed cultivation system of claim 19, wherein the genus of engaged immature seaweed plants are selected from the group comprising Palmaria, Porphyra, Saccharina, Neopyropia Grasscilaria, kelp, and Asparagopsis.

22. The seaweed cultivation system of claim 21, wherein the engaged immature seaweed plants are Palmaria.

23. The seaweed cultivation system of claim 19, wherein the plurality of immature seaweed plants engages the catchment surface during an initial seeding process to define a first portion of immature seaweed plants that are securely entrapped by the catchment surface and a second portion of immature seaweed plants that are temporarily entrapped by the catchment surface until subjected to a water current, and
wherein greater than 50% of the plurality of immature seaweed plants are the first portion that are retained after exposure to the water current.

24. The seaweed cultivation system of claim 23, wherein the water current is created through exposure to a flume process immediately after completion of the initial seeding and a percentage of retained immature seaweed plants is ascertainable immediately subsequent to the flume process.

25. The seaweed cultivation system of claim 19, wherein the plurality of immature seaweed plants engages the catchment surface during an initial seeding process to define a first portion of immature seaweed plants that are securely entrapped by the catchment surface and a second portion of immature seaweed plants that are temporarily adhered to the catchment surface until subjected to an incubation period, and
wherein greater than 50% of the plurality of immature seaweed plants are the first portion that are retained after the expiration of the incubation period.

26. The seaweed cultivation system of claim 25, wherein an expiration of the incubation period takes place approximately two weeks after the initial seeding and a percentage of retained immature seaweed plants is ascertainable at the expiration of the incubation period.

27. The seaweed cultivation system of claim 19, wherein the plurality of immature seaweed plants engages the catchment surface during an initial seeding process followed by an incubation period to define a first portion of immature seaweed plants that are securely entrapped by the catchment surface and a second portion of immature seaweed plants that are temporarily entrapped by the catchment surface until subjected to a submersion in an oceanic farming environment, and
wherein greater than 50% of the plurality of immature seaweed plants are the first portion that are retained after the submersion in the oceanic farming environment.

28. The seaweed cultivation system of claim 27, wherein the submersion in the oceanic farming environment takes place approximately four weeks after the initial seeding and a percentage of retained immature seaweed plants is ascertainable during the submersion in the oceanic farming environment.

29. The seaweed cultivation system of claim 27, wherein the submersion in the oceanic farming environment takes place approximately four weeks after the initial seeding and a percentage of retained immature seaweed plants is ascertainable during a harvesting from the oceanic farming environment.

30. The seaweed cultivation system of claim 19, wherein the lodged immature seaweed plants are retained via selective attachment upon intentionally differentiated surface textures.

31. A laid rope for use in seaweed cultivation, the laid rope having a rope axis and rope axial length, the rope including a first yarn and a second yarn,
wherein the first yarn includes a first growth fiber and a first strength fiber, wherein the first growth fiber and the first strength fiber axially are aligned and twisted about each other to define a first left-handed twisting fiber-to-fiber engagement,
wherein the second yarn includes a second growth fiber and a second strength fiber, wherein the second growth fiber and the second strength fiber are axially aligned and twisted about each other to define a second left-handed twisting fiber-to-fiber engagement,
wherein the first yarn and the second yarn are axially aligned and twisted about each other to define a right handed twisting yarn-to-yarn engagement, wherein the first left-handed twisting fiber-to-fiber engagement disposes the first strength fiber and the first growth fiber to define a first contact line along the rope axial length where one fiber repeatedly contacts the other fiber, the first contact line further defining adjacent portions of the first strength fiber and the first growth fiber that are in an angular relationship to each other to define a first groove of the first yarn,
wherein the second left-handed twisting fiber-to-fiber engagement disposes the second strength fiber and the second growth fiber to define a second contact line along the rope axial length where one fiber repeatedly contacts the other fiber, the second contact line further defining adjacent portions of the second strength fiber and the second growth fiber that are in an angular relationship to each other to define a second groove of the second yarn.

32. The laid rope of claim 31 wherein the first growth fiber and the second growth being expanded polyethylene.

33. The laid rope of claim 32 wherein the first growth fiber and the second growth fiber are monofilament polypropylene.

34. The laid rope of claim 31, wherein a catchment enhancing fiber is included in first yarn, the second yarn, or both the first and second yarn.

35. The laid rope of claim 34, wherein the catchment enhancing fiber is spun polyester.

36. The laid rope of claim 31 having a loose twist that moves between the loose and taught states to define a second configuration of the groove.

37. The laid rope of claim 31, wherein the distance from the top to the trough of the groove is 0.5-1 mm or more.

38. A seaweed cultivation system comprising a laid rope of claim 31.

39. A seaweed cultivation system of claim 36, wherein the plurality of immature seaweed plants engage the first groove and second groove along the length of the laid rope during an initial seeding process.

40. A seaweed cultivation system of claim 39, wherein the laid rope is knotted to form a net.
